(19) United States
(12) Patent Application Publication
(10) Pub. No.: US 2016/0232468 A1
(43) Pub. Date: Aug. 11, 2016

(54) SYSTEM AND METHOD FOR QUEUE MANAGEMENT

(71) Applicant: QU-U-UP VSA LTD., Zichron Yaacov (IL)

(72) Inventors: Dror MEIRI, Zichron Yaacov (IL); Joseph SHAZAR, Zichron Yaacov (IL)

(73) Assignee: QU-U-UP VSA LTD., Zichron Yaacov (IL)

(21) Appl. No.: 15/015,738

(22) Filed: Feb. 4, 2016

Related U.S. Application Data
(60) Provisional application No. 62/112,388, filed on Feb. 5, 2015.

(51) Int. Cl. G06Q 10/06; G06Q 10/08

(52) U.S. Cl. CPC G06Q 10/06315; G06Q 10/087

(57) ABSTRACT

A system and method for automatic queue management of resources are presented. The method includes receiving a selection of an unavailable resource from a selecting user entity, wherein the selected resource is associated with a queue order including at least one queued entity; updating the queue order of the selected resource based on the received selection; monitoring resource availability information of the selected resource to identify changes in an availability of the selected resource; and upon detecting a change in the availability of the selected resource: automatically assigning the detected available resource to the next queued entity in the queue order; and updating the queue order based on the assignment.

### CROSS-REFERENCE TO RELATED APPLICATIONS

This application claims the benefit of U.S. Provisional Application No. 62/112,388 filed on Feb. 5, 2015, the contents of which are hereby incorporated by reference.

### TECHNICAL FIELD

The present disclosure relates generally to queue management, and more particularly to managing queue information among a variety of sources.

### BACKGROUND

When reserving appointments, travel accommodations, seating arrangements, and other resources that are unique to one person or group of people at any given time, such people may prefer particular resources. As an example, a customer seeking plane tickets may wish to have an aisle seat, or may have a preference for sitting closer to either the front or the back of the plane. As another example, a customer may prefer a particular time and/or day for a doctor's appointment.

With the increasing prevalence of computers and the Internet, resource owners who control distribution of these unique resources began offering the ability for customers to access electronic records regarding resource availability. These electronic records may include resource maps that visually demonstrate availability (e.g., a seating chart, a digital calendar, and so on). Further, customers may be able to select among available resources instantly via the Internet, mobile applications, phone services, reservation centers, and so on. This selection allows customers to choose their preferred resources, at least among currently available resources.

With respect to unavailable resources, existing solutions typically require a customer or other reserving entity to manually revisit the electronic records at a later time to update reservations. Some existing solutions alert a customer as to when a resource specifically requested by the customer becomes available. However, customers using such existing solutions face challenges regarding obtaining suitable reservations when their preferred resources do not become available and/or are reserved by another customer who was able to access the electronic records more quickly.

Other existing solutions utilize a queue to determine priority when resources become available. The queue-based solutions typically utilize a human agent to manually record customer preferences and reassign newly freed up resources accordingly. These solutions are significantly hampered by the need for manual recording and reassignment, and may be impractical or impossible to implement on a larger scale. Further, these solutions do not provide optimal speed or computing resource usage, and do not necessarily reassign resources in real-time.

The existing solutions face further challenges in coordinating queues for multiple resources simultaneously. For example, customers may wish to sit in adjacent seats when traveling or viewing a show. The existing solutions may be unable to efficiently identify groups of available resources, thereby prompting customers to cancel or otherwise change their plans.

As a result of such challenges, customers may not reassign resources, thereby frustrating customers and diminishing customer experiences. In some cases, a customer may have to cancel a reservation entirely, which may result in additional fees and penalties. For the resource owner, this may result in lost profits and/or reputational harm.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some embodiments disclosed herein include a method for automatic queue management of resources. The method comprises receiving a selection of an unavailable resource from a selecting user entity, wherein the selected resource is associated with a queue order including at least one queued entity; updating the queue order of the selected resource based on the received selection; monitoring resource availability information of the selected resource to identify changes in an availability of the selected resource; and upon detecting a change in the availability of the selected resource: automatically assigning the detected available resource to the next queued entity in the queue order; and updating the queue order based on the assignment.

Some embodiments disclosed herein also include a system for automatic queue management of resources. The system comprises a processing unit; and a memory, the memory containing instructions that, when executed by the processing unit, configure the system to: receiving a selection of an unavailable resource from a selecting user entity, wherein the selected unavailable resource is associated with a queue order including at least one queued entity; updating the queue order of the selected resource based on the received selection; continuously monitoring resource availability information of the selected resource to detect changes in availability of the selected resource; and upon detecting an availability of the selected resource: automatically assigning the detected available resource to the next queued entity in the queue order; and updating the queue order based on the assignment.

Some embodiments disclosed herein also include a method for generating resource recommendations based on a resource preference history. The method comprises retrieving historical data related to resource preferences; analyzing the historical data to identify the resource preferences; retrieving availability information of at least one resource matching the resource preferences; determining, based on the availability information, whether each matching resource is available; upon determining that at least one matching resource is available, generating a recommendation including one of the at least one available matching resource.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for assigning resources based on user inputs.

FIG. 3 is a flowchart illustrating a method for managing a queue according to an embodiment.

FIG. 4 is a flowchart illustrating a method for automatically managing queues for a plurality of resources according to an embodiment.

FIG. 5 is a flowchart illustrating a method for bidding for queue order according to an embodiment.

FIG. 6 is a flowchart illustrating a method for queue-based resource recommendation according to an embodiment.

FIG. 7 is a flowchart illustrating a method for generating resource recommendations based on user histories according to an embodiment.

FIGS. 8A and 8B are exemplary resource maps.

FIGS. 9A through 9C are exemplary queue data tables.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

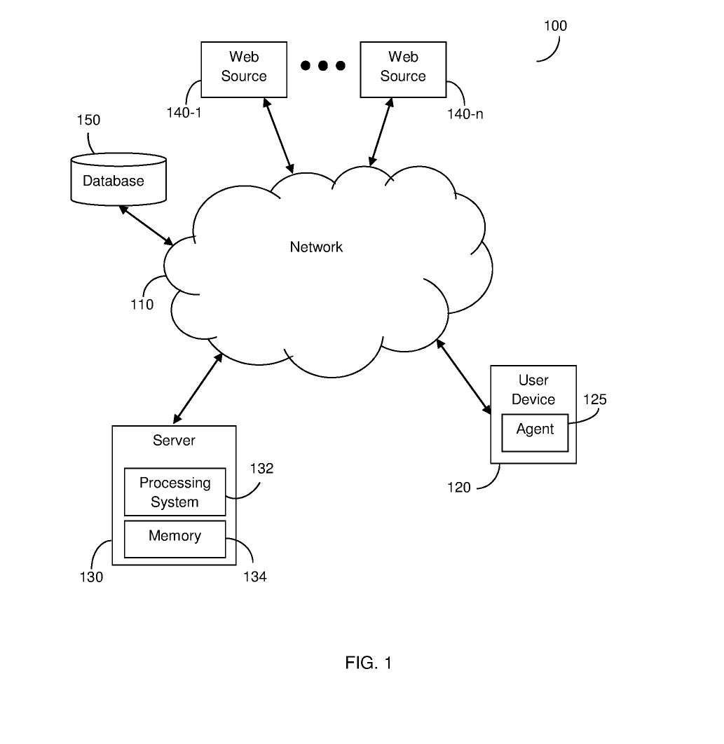

FIG. 1 shows an exemplary and non-limiting network diagram 100 utilized to describe the various disclosed embodiments. A network 110 is communicatively connected to a user device 120, a server 130, a plurality of web sources 140 (hereinafter referred to individually as a web source 140 and collectively as web sources 140, merely for simplicity purposes), and a database 150. The network 110 may be, but is not limited to, a local area network (LAN), a wide area network (WAN), a metro area network (MAN), the worldwide web (WWW), the Internet, a wired network, a wireless network, similar networks and any combinations thereof.

The user device 120 may be, but is not limited to, a personal computer, a laptop, a tablet computer, a smartphone, a wearable computing device, and so on. The user device 120 may be installed with an agent 125 which may be, but is not limited to, an application. An application executed or accessed via the user device 120 may be, but is not limited to, a mobile application, a virtual application, a web application, a native application, and the like. The user device 120 may be utilized by any entity that is subject to a queue including, but not limited to, a passenger, a guest, a spectator, a user, a customer, a patient, an agent or other representative, and so on.

The web sources 140 may include, but are not limited to, servers of resource owners and/or of third parties associated with resource owners. The web sources 140 may store and allow for retrieval of files including information such as, but not limited to, resource availability. Each of the web sources may be operated by a resource owner or third party such as, but not limited to, airlines, theaters, stadiums, hotels, restaurants, parking garages, shopping centers, reservation centers, hospitals, appointment-makers, holding companies thereof, chains thereof, resellers of resources, and any other owner and/or controller of resources.

The user device 120 and/or the agent 125 may receive user inputs including, but not limited to, selections of resources, resource preferences, weight factor values, and so on. A resource can be tangible or intangible and may include, but is not limited to, a seat (in a plane, train, theater, sport venue, etc.), a bed, a table (e.g., in a restaurant), a time slot, a room, a physical space (e.g., a parking spot), any item for purchase, and any other resource that can only be possessed, owned, or otherwise with limitations on availability. A weight factor value may include, but is not limited to, a price the user is willing to pay, user profile information indicating a status in a loyalty program, and so on.

The resource preferences may include, but are not limited to, a type of resource (e.g., hotel reservations, appointments, plane tickets, concert tickets, etc.), a geographic location of the resource (e.g., a flight leaving from a particular state or airport, a particular concert hall, a neighborhood of a parking garage, etc.), a relative location of the resource (e.g., a particular seat, aisle, row, column, section, box, table, bed, floor, wing, etc.), a time of resource use (e.g., a particular time period), and so on.

The resource preferences may further include preferences for related resources such as, but not limited to, availability of related resources for purchase, assignments (or lack thereof) of related resources, and so on. As an example, a wife seeking to sit on a bus ride with her husband may select a preference criteria indicating that she would like a seat that is adjacent to an available seat. As another example, a patient hoping to avoid waiting at a doctor's office due to a long visit by another patient may select a preference criteria indicating that he or she would prefer a time slot following an unassigned time slot.

In a further embodiment, the user device 120 and/or the agent 125 may further receive, from the server 130 and/or from one of the web sources 140, one or more resource maps illustrating resource availability, and may display the resource maps. Each resource map may further indicate a queue for each resource. The user device 120 and/or the agent 125 may receive the user inputs respective of the displayed resource maps.

In an embodiment, the server 130 may be further configured to retrieve one or more resource constraints from any of the web sources 140. The resource constraints may be selected by the resource owners and may include restrictions on resource allocation. For example, a restaurant owner may wish to control seating within a restaurant to ensure fair distribution of tables among wait staff. As another example, an airline company may wish to ensure that airplane passengers are somewhat evenly distributed between the left and right sides of the airplane and/or that passengers with a specific status have seating priority.

The user inputs may further include a preference ranking associated with each resource preference and indicating its relative importance. For example, an airline customer may slightly prefer an aisle seat, but would not prefer an aisle seat over a seat of an airplane departing from a particular airport. The airline customer may assign a preference ranking of 5 to the aisle seat resource preference and 9 to a choice of a particular airport, with 1 being the lowest importance and 10 being the highest importance.

In an embodiment, the server 130 may be configured to receive selections of resources from the user via the user device 120 and/or the agent 125. In a further embodiment, the server 130 may be configured to receive resource preferences from the user via the user device 120 and/or the agent 125, and to manage one or more queues respective of each of the web sources 140.

Each queue may be associated with a particular resource and may include user entities such as persons, groups, organizations, and any other entity that may utilize a resource. The server 130 is further configured to manage the queues. The queue management may include, but is not limited to, adding users to queues, reorganizing queues based on weight factors, and monitoring resource availability. Information regarding updates to the queues may be provided to appropriate web sources 140 for each queue (e.g., updates to a queue for a seat on a plane may be sent to a web source associated with the owner of the plane). The monitoring may include periodically checking the resource maps or continuously checking resource maps to detect changes thereto.

Upon detecting a change in a resource map indicating that a resource has become available, the server 130 may be configured to automatically assign a user to the newly available resource based on the order of the queue. The server 130 may be further configured to update assignment information related to the resource in the respective web source 140. Upon automatic assignment of a resource to a user, the user may be charged for the resource. Alternatively, a third party may be charged for the resource (e.g., a travel agent may be billed for its client's selection of a plane seat). Charging for the resource may include, e.g., sending a bill for the resource, charging a predetermined credit or debit card, subtracting credits from a user account, redeeming points (e.g., frequent flyer miles) and so on. Alternatively or collectively, the assignment may be temporary (e.g., until a predetermined amount of time passes), thereby allowing a user of the user device 120 a limited amount of time in which to secure the resource (by, e.g., confirming and/or paying for the assignment). The server 130 may be further configured to generate a notification regarding the assignment and to send the notification to the user device 120. The notification may include a request to confirm and/or pay for the assignment.

The order may be based on a first in first out organization (i.e., the earliest remaining user is the first in the order), on a weighted organization, or on a combination thereof. For a weighted organization, the queue order is based on weight factors associated with each user. The weight factors may be determined based on, but not limited to, a price the user is willing to pay, a status in a loyalty program, a class of reservation, combinations thereof, and so on. The weight factors may be retrieved from, e.g., one of the web sources 140. The determination of weight factors may include a bidding process in which each user provides a value for each weighted factor. For example, users may provide prices they would be willing to pay for a particular resource, with the highest bidder being the first in the queue. In an embodiment, a bidding process may occur when, e.g., a new user is introduced to the queue, and the weight factors and/or queue may be updated accordingly.

In an embodiment, each user may be associated with multiple queues simultaneously. In a further embodiment, upon assignment of a user that is associated with multiple queues of the same type to a resource, the user may be removed from other queues of the same type. In yet a further embodiment, the user may only be removed from same-type queues associated with equal or lesser resource preferences. For example, a potential hotel guest on two queues for hotel reservations in Orlando, Fla., may assign a preference ranking of 5 for a first floor room and a preference ranking of 8 for a room within 5 miles of a particular amusement park. If a first floor room in a hotel that is 10 miles of the amusement park becomes available, the guest may be automatically assigned to the first floor room, but the guest will remain in a queue for a room in a hotel that is within 5 miles of the amusement park.

In another embodiment, a user associated with multiple resources may ascribe a priority score to each resource. In a further embodiment, the server 130 may be configured to iteratively check availability of the multiple resources until the user is assigned the resource having the highest priority score.

In an embodiment, the server 130 may be configured to store, in the database 150, the resource preferences and/or rankings of the user using the user device 120 respective of various types of resources. The stored resource preference data may be utilized to determine similar or equivalent resources to offer to the user. The determination may be further based on other information related to the user of the user device 120 (e.g., a geographic location, a user profile, and so on) and/or the resource (e.g., a time, a location, a subject matter, and so on). For example, an airline customer looking for a particular flight may prefer an EXIT seat when no EXIT seat is available. The seat preference may be utilized to determine that the customer may be interested in another flight departing from a similar place and time featuring an available EXIT seat.

In a further embodiment, the server 130 may be configured to generate a resource preference profile for the user using the user device 120. The resource preference profile may be based on the types of resources and/or the resource preferences. In another embodiment, the server 130 may also be configured to identify resource events from the web sources 140. Each resource event may be associated with a particular type of resource and may be associated with one or more of the resource preferences. A resource event may be, but is not limited to, an appointment, a trip (e.g., a plane flight, a train ride, etc.), a show (e.g., a concert, a movie, a play, etc.), a lodging stay (e.g., a stay at a hotel), and so on.

In yet a further embodiment, the server 130 may be configured to match resources of identified resource events to the resource preference profile of a user to determine a recommended resource of an identified resource event. The server 130 may be configured to temporarily assign the recommended resource to the user associated with the matching resource preference profile. The server 130 may be further configured to send a notification regarding the recommended resource to the user device 120 when the recommended resource is available. The notification may include, but is not limited to, a link to a web page in which the user can request the resource, an indication of the duration of the temporary assignment, availability of similar resources (e.g., similar location, time, and/or subject matter), and so on.

As a non-limiting example of providing resource recommendations, based on previous resource preferences selected by a theater patron, the server 130 may generate a resource preference profile indicating that the patron prefers to go to comedy shows and sit in the first row. Based on the resource preference profile, the server 130 may identify a comedy show in which a front row seat is available and may assign the seat to the patron for 12 hours to allow the patron a chance to purchase the seat. The server 130 may further generate and send a notification including a link to the show's web page and an indication that the seat will be reserved for the patron for 12 hours.

In an embodiment, the server 130 may be configured to cause a display of a user interface for viewing resource availability, queue availability, queue orders, monitoring updates, resource preferences, and the like. The user interface may be displayed on a device of an entity controlling the resources, and may allow the user to input changes to resource preferences.

In an embodiment, actions for controlling queue management on a device (not shown) operated by, e.g., a resource owner may be enabled through the user interface. For example, the queue management control user interface may allow a resource owner to manually control aspects of queue management via, but not limited to, pausing queue management (i.e., preventing modifications to a queue order), resuming a paused queue management, inserting a user into a queue (e.g., at the end of the queue or at a specific place in the queue order), modifying resource constraints, removing users from queues, modifying bids (e.g., raising or lowering a starting bid), and so on.

In another embodiment, the server 130 may be configured to allow the user to search resources of events (e.g., flights, shows, service providers, and so on) based on his or her resource preferences. For example, a user may provide or have previously stored resource preferences for seeing a Broadway show and sitting in an aisle seat in one of the middle rows and request a recommendation for a similar or otherwise suitable resource. Based on the resource preferences, an available aisle seat in a middle row for a Broadway show may be determined, and the user may be notified of a recommendation respective thereof.

It should be understood that the embodiments disclosed herein are not limited to the specific architecture illustrated in FIG. 1, and other architectures may be equally used without departing from the scope of the disclosed embodiments. Specifically, the server 130 may reside in a cloud computing platform, a datacenter, and the like. Moreover, in an embodiment, there may be a plurality of servers operating as described hereinabove and configured to either have one as a standby, to share the load between them, or to split the functions between them.

The server 130 typically includes a processing system or processing circuitry 132 coupled to a memory 134. The processing system or circuitry 132 may comprise or be a component of a processor (not shown) or an array of processors coupled to the memory 134. The memory 134 contain instructions that can be executed by the processing system or circuitry 132. The instructions, when executed by the processing system or circuitry 132, cause the processing system or circuitry 132 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system or processing circuitry 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

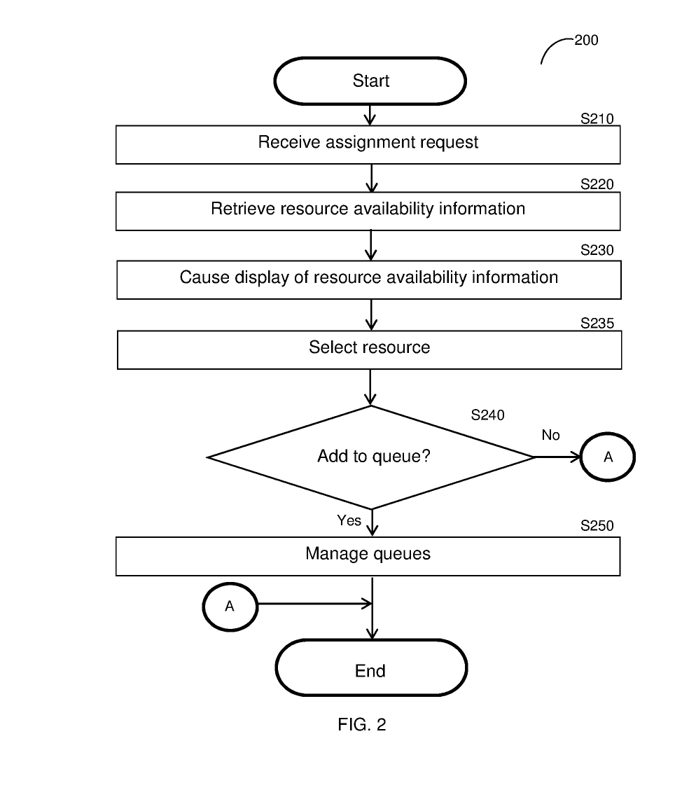

FIG. 2 is an exemplary and non-limiting flowchart 200 illustrating a method of assigning resources based on user inputs. In an embodiment, the method of FIG. 2 may be performed by a server (e.g., the server 130).

In S210, a request to assign resources to a user is received. The request may include, but is not limited to, a selection of a type of resource, a selection of one or more resource owners, a selection of a particular grouping of resources (e.g., a particular location, time, and so on), or any other information for determining potential sources of resources (e.g., web sources owned by particular resource owners).

In S220, resource availability information is retrieved respective of the request. The resource availability information may include, but is not limited to, available sources of resources (e.g., particular resource owners having available resources) which resources are currently available, a queue for each resource, a resource map illustrating resource availability, and so on.

In S230, the resource availability information is caused to be displayed on the requesting device (e.g., the user device 120). In optional S235, a resource may be selected among the available resources. If no resource is selected, a default resource may be automatically selected.

In S240, it is determined whether the user's request should be placed on one or more queues and, if so, execution continues with S250; otherwise, execution terminates. The determination may include, but is not limited to, receiving a selection of an unavailable resource, prompting the user for a response to the selected available resource (i.e., if the user is not satisfied with the resource, he or she should be placed on a queue for a more suitable resource), prompting the user to register for a queue, a combination thereof, and so on.

In S250, upon determining that the user should be placed on one or more queues, the user may be added to the queues and the queues are managed to determine potential new resources to be assigned to the user. In an embodiment, the user may be allowed to add and/or remove himself or herself to or from the queue or other queues prior to use of the resource. Such subsequent additions and removals allow the user to continue seeking more preferred resources as they become available and/or as user preferences change.

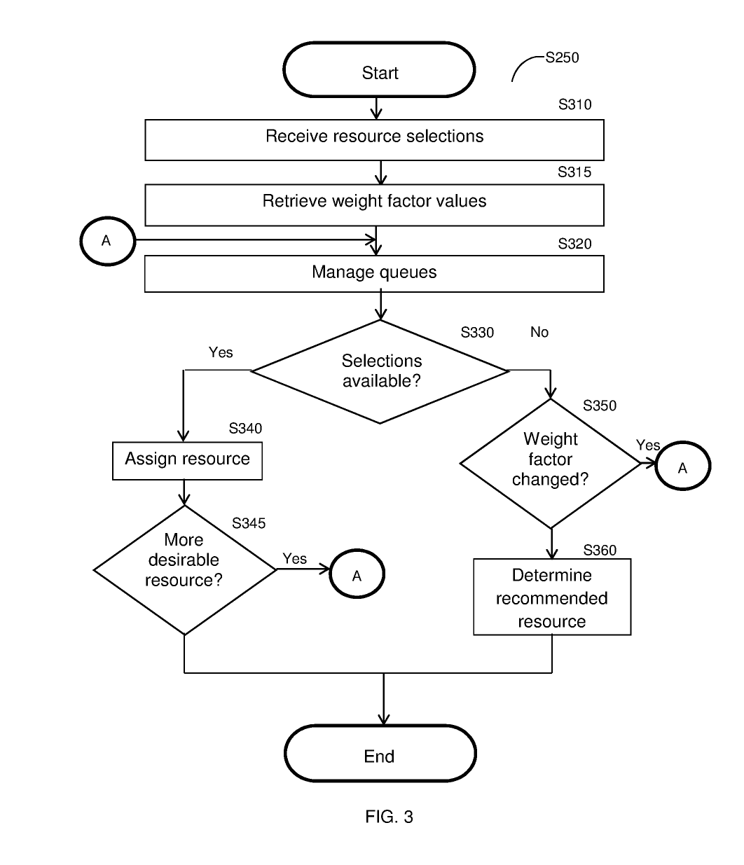

An exemplary and non-limiting method S250 for queue management is illustrated in FIG. 3. In an embodiment, S250 may begin upon receiving a request to add a user to one or more queues.

In S310, one or more resource selections are received. In an embodiment, the resource selections may be received respective of a resource map displayed to the user. The resource selections may be for a particular resource and/or for a group of resources.

In an embodiment, S310 may further include receiving resource preferences and/or resource constraints. The resource preferences may indicate criteria for selecting alternative resources that may be suitable for the user. For example, the resource preferences of a user seeking to buy a plane ticket may indicate the user's preference for an aisle seat. The resource preferences may further indicate preferences for related resources (e.g., physically or temporally adjacent resources, resources in the same row, resources in the same section, and so on). The resource constraints may be retrieved from a resource owner (via, e.g., a web source). The resource constraints may be restrictions placed upon resource selection. As an example, a bus company may place a constraint on sitting next to empty seats.

In optional S315, one or more weight factor values of the user may be received or retrieved. The weight factor values may be utilized to determine an order of a user representing the user in a weighted queue. For example, a user that is a “gold” member in a rewards program may be placed earlier in a queue than “bronze” or “silver” member in the rewards program.

In S320, queues are managed based on the resource selections, resource preferences, resource constraints, and/or weight factor values. The queue management may include, but is not limited to, updating each queue to include a queue element associated with the user, reorganizing each weighted queue based on the weight factor values, reorganizing the queues based on probabilities, and/or monitoring the queues to detect changes in availability of the selected resource.

In an embodiment, S320 may further include determining a probability that the user will obtain a new resource of the same type (e.g., seat, ticket, space, reservation, and so on) based on the queue. The probability determination may be based on, but is not limited to, a number of queues the user is in, an order of the user within each queue, whether earlier order users in each queue are seeking additional resources, combinations thereof, and the like. As an example, a probability for a user who is in two queues may be higher than that of a user who is only in one queue. As another example, a probability for a user who is first in a queue order may be higher than that of a user who is second in a queue order. As yet another example, a probability for a second user in a queue order may be higher when the first user in the queue order is in queues for other resources than when the first user is not in any other queues.

In a further embodiment, the queues may be reorganized to maximize the overall probabilities of users obtaining new resources and/or that all available resources will be taken. The overall probability may be, but is not limited to, a total probability, an average probability, and so on. The reorganization may be based on one or more estimated probabilities for reorganizational changes.

As a non-limiting example, John may be first in the queue for resources A, B, and C, thereby resulting in a probability of P1 that John will obtain a new resource. Mary may be second in the queue for resource A only, thereby resulting in a probability of P2 that Mary will obtain a new resource, where P1>P2. It is determined that reorganizing the queue for resource A such that Mary is first in the queue order and John is second will result in estimated new probabilities of P3 and P4 for John and Mary, respectively, where P3+P4>P1+P2. Thus, it is determined that reorganizing the queue order will result in a higher total probability, and the queue for resource A is reorganized accordingly.

As another example, Joe requests resources A and B and Adam requests only resource A. In order to maximize occupation of resources, Adam will be placed in resource A, regardless of Adam's priority. This ensures that Joe will be placed in resource B. Providing a different assignment would result in Joe being assigned to resource A and Adam's request not being served, thereby leaving resource B vacant.

In an embodiment, the monitoring may include checking for updates to the resource availability. Checking for updates may include, but is not limited to, retrieving a current resource map and comparing the current resource map to the most recent previous resource map. The current resource map may be retrieved continuously, at regular intervals, upon identification of a change in the resource map, and so on. In an embodiment, identifying changes in the resource map may include configuring an agent (e.g., a script code or executable program) associated with the resource map to detect changes to the resource map and to send notifications when the resource map has changed. Upon receiving such a notification, a change may be identified. Based on the comparison, it may be determined whether the resource map has changed and, if so, queues associated with resources of the changed resource map may be updated.

In an embodiment, the frequency of retrieval may be different at different times. In a further embodiment, the frequency of retrieval may change based on a frequency schedule including frequencies of retrieval at during various time periods. Such mutable retrieval frequencies allow for more efficient use of computing resources by checking for changes more frequently when changes are more likely to occur. In a further embodiment, machine learning can be utilized to optimize the retrieval frequency. As an example for changing retrieval frequency, resource maps for plane tickets departing airports in Tokyo may be checked more frequently between 8 AM and 10 PM Tokyo time, as passengers are more likely to purchase tickets during those hours. As another example, retrieval of a resource map related to a show may be more frequent during the week leading up to the show. As yet another example, if machine learning analysis indicated that parking spots in a particular parking lot are frequently reserved the night before the reservation, then a resource map for Tuesday parking reservations may be checked more frequently on the preceding Monday.

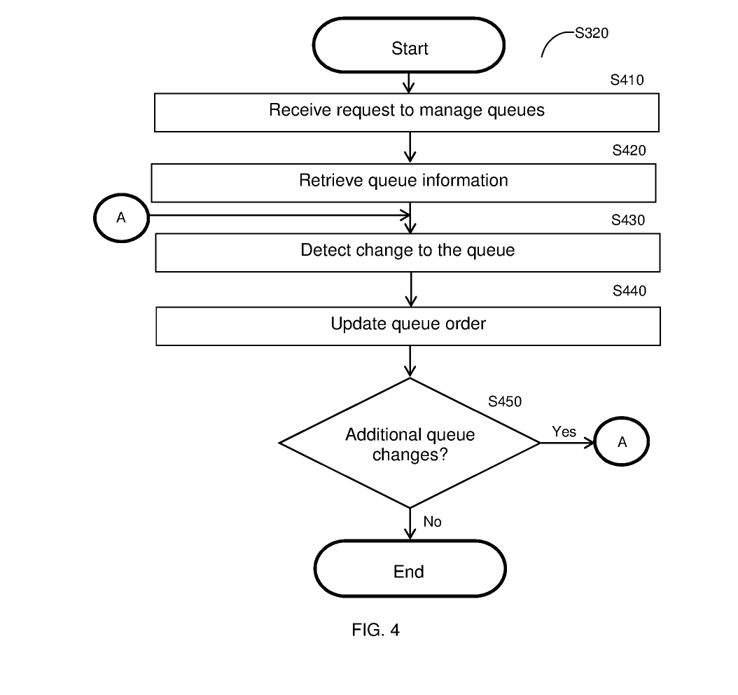

In S330, based on the queue management, it is determined whether any of the selected resources or groups of resources have become available to the user respective of the user's request. If so, execution continues with S340; otherwise, execution continues with S350. A resource may become available to the user device if, e.g., the currently assigned user is cancelled (i.e., a user of the user device cancels a reservation of a resource) when the user of the user device is next in the queue. In an embodiment, S330 may include continuously checking for availability based on the monitoring and/or checking for availability of each resource at predetermined time intervals. Queue management is described further herein below with respect to FIG. 4.

In S340, upon determining that one of the selected resources has become available to the user, the resource may be automatically assigned to the next user in the queue. In an embodiment, the user may be prompted to confirm the resource assignment. Prompting the user may include sending a notification to a user device of the user. In a further embodiment, the resource may be temporarily assigned to the user. The temporary assignment may expire after, e.g., a predetermined period of time, when the queue order of the resource changes (i.e., when a user having a higher weight factor is added to a weighted queue), and so on. After the temporary assignment expires, the user may be removed from the queue.

In optional S345, it may be determined, based on the resource preferences, whether there is a more desirable resource and, if so, execution continues with S320 using the more desirable resource as the selected resource; otherwise, execution terminates. A resource may be more desirable than another resource if, e.g., it has a higher preference ranking. In another embodiment, the user may assign desirability rankings when selecting multiple resource. In a further embodiment, a resource is more desirable than another resource if it is assigned a higher desirability ranking. Offering more desirable resources may provide a user with options that he or she did not realize existed.

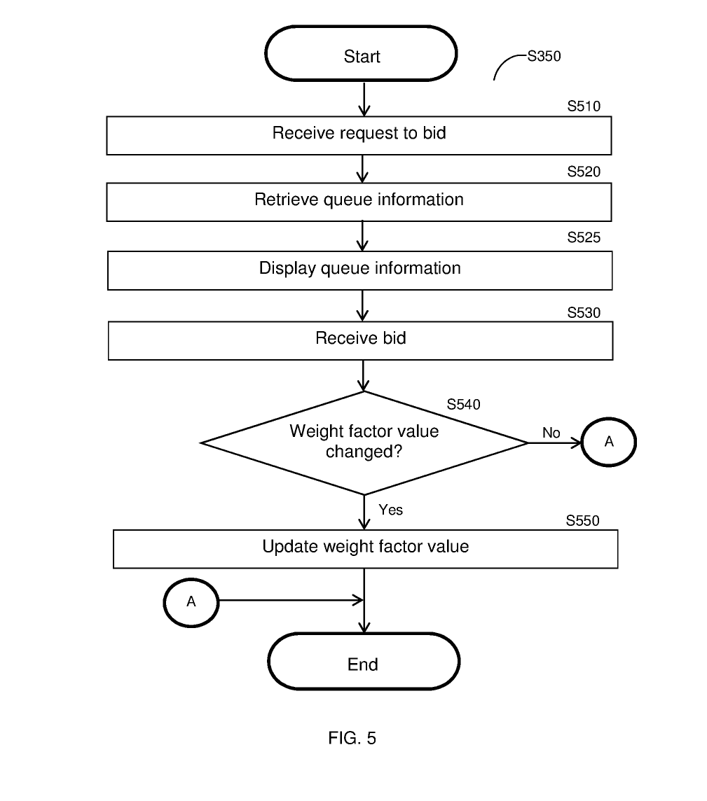

In optional S350, upon determining that none of the selected resources are available, it may be determined if the weight factor of the user has changed. If so, the weight factor may be updated and execution continues with S320; otherwise, execution continues with S360. Determining whether the weight factor has been changed may be based on a bid submitted by the user. The bidding may allow, e.g., the user to obtain an earlier order in a weighted que by submitting a higher weight factor value. For example, the user who is willing to pay the most for a resource may be first in the queue order. In an embodiment, the bidding may only be performed for weighted queues. Bidding for queue order is described further herein below with respect to FIG. 5.

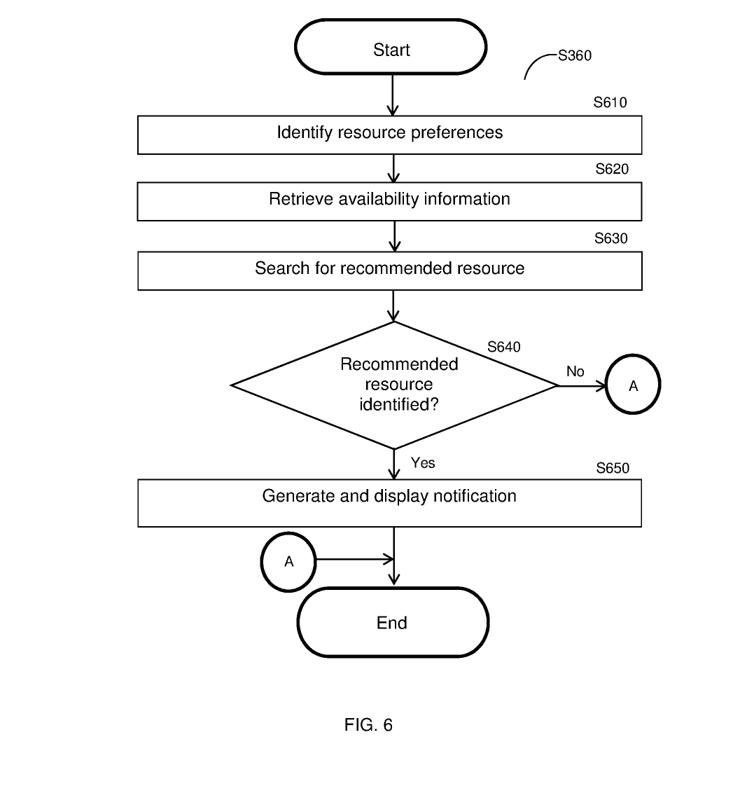

In optional S360, a recommended resource may be determined based on the received resource preferences when the selected resource(s) are not available. The recommendation may be for an available resource, or may be for an unavailable resource. If the recommendation is for an available resource, the user may be assigned to the recommended resource. Queue-based resource recommendation is described further herein below with respect to FIG. 6.

As a non-limiting example, a dental patient selects a time slot of 7-8 PM for a dental appointment on a particular Monday and provides a preference of appointments after 6 PM. The dentist's office has a first in first out queue. It is determined that the 7-8 PM time slot is not yet available and that there are no patients currently in the queue for the 7-8 PM time slot. The patient is added to the queue for the 7-8 PM time slot as the first queued patient. A recommendation for an available 6-7 PM appointment on the following Monday is determined, and a notification including the recommended appointment is sent to the patient. The patient accepts the 6-7 PM appointment. If the 7-8 PM appointment subsequently becomes available, the patient, being first in the queue, may be prompted to confirm reassignment to the 7-8 PM appointment and/or may be automatically assigned to the 7-8 PM appointment.

As another non-limiting example, a moviegoer may select a first movie theater ticket for a particular movie having a start time of 7 PM and a location within 2 miles of her home. The moviegoer may further provide resource preferences indicating that she would prefer a start time between 5 and 6 PM over a theater within 2 miles of her home and, accordingly, may assign a rank of 8 to start times between 5 and 6 PM, and a rank of 2 to theaters within 2 miles of her home. The moviegoer is assigned to a user in a queue for the first ticket, and the ticket subsequently becomes available while the moviegoer is the first in the queue. The moviegoer is prompted to confirm the ticket assignment. It is further determined that there are more desirable tickets for a movie having a start time of 5:30 PM located 5 miles away from her home. The moviegoer is placed in a queue for one of the more desirable tickets, and is notified when the more desirable ticket is available.

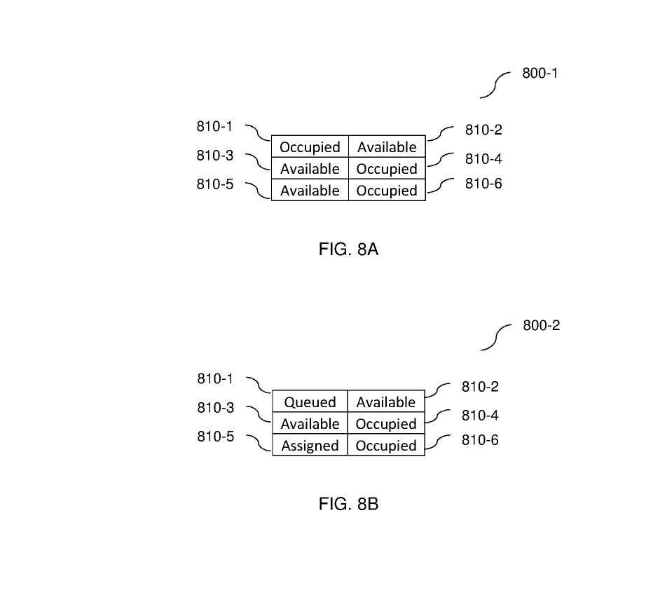

Exemplary and non-limiting illustrations of resource maps 800-1 and 800-2 according to the method of FIG. 3 is seen in FIGS. 8A and 8B, respectively. The resource maps 800-1 and 800-2 represent a seating chart for, e.g., an airplane. Each of the resource maps 800-1 and 800-2 includes a plurality of seats 810-1 through 810-6. Each of the seats 810 may be occupied with no queue, queued (i.e., one or more users are in the queue for the resource), or available. The resource map 800-2 illustrates a resource map after receiving user's inputs. The resource map 800-2 indicates that the user has been assigned the available seat 810-5. Additionally, the resource map 800-2 indicates that the user has selected unavailable seat 810-1, thereby being placed on the queue for that seat.

FIG. 4 is an exemplary and non-limiting flowchart S320 illustrating a method for automatically managing queues for a plurality of resources according to an embodiment.

In S410, a request to manage queues for the plurality of resources is received. The request may identify the queues to be managed, the resources, and/or data sources associated with the resources (e.g., web sources).

In S420, queue information is retrieved. The queue information may include, but is not limited to, an ordering scheme (e.g., first in first out, weighted, and so on), existing queues for the resources, information about users in the existing queues, information about users that are assigned resources, and so on.

In S430, a change to one of the queues is detected. The change to the queue may be detected based on, but not limited to, a user selection of an unavailable resource, a new weight factor for a user associated with a user of the queue, a cancellation of a resource reservation, and so on. Detecting cancellations of resource reservations may include, but is not limited to probing a resource map at predetermined time intervals and/or receiving a notification regarding a cancelled reservation.

In S440, based on the change to one of the queues, the queue order of the changed queue is automatically updated. Updating the queue order may include, but is not limited to, adding a new user when a user selects an unavailable resource, reorganizing the queue order when a new weight factor is provided for a user in the queue, advancing each user within the queue order when a reservation is cancelled, and so on. In an embodiment, if a user would be advanced when it is first in the queue order, the user may be assigned the resource.

In S450, it is checked whether additional queue changes have been detected and, if so, execution continues with S430; otherwise, execution terminates.

It should be noted that the embodiments described herein above with respect to FIG. 4 are discussed with respect to one set of resources merely for simplicity purposes and without limitation on the disclosed embodiments. The method of FIG. 4 may be applied to multiple sets of resources to simultaneously manage queues for different sets of resources without departing from the scope of the disclosure.

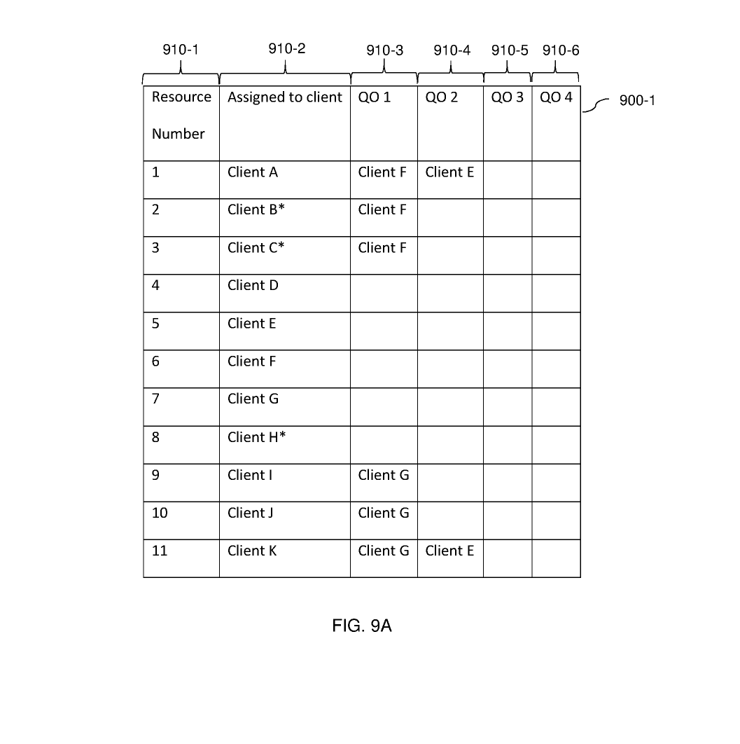

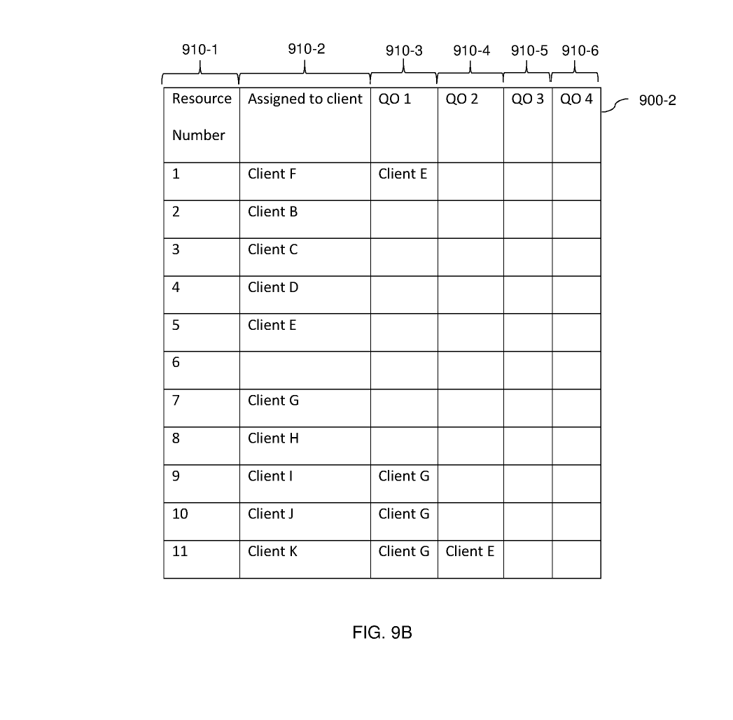

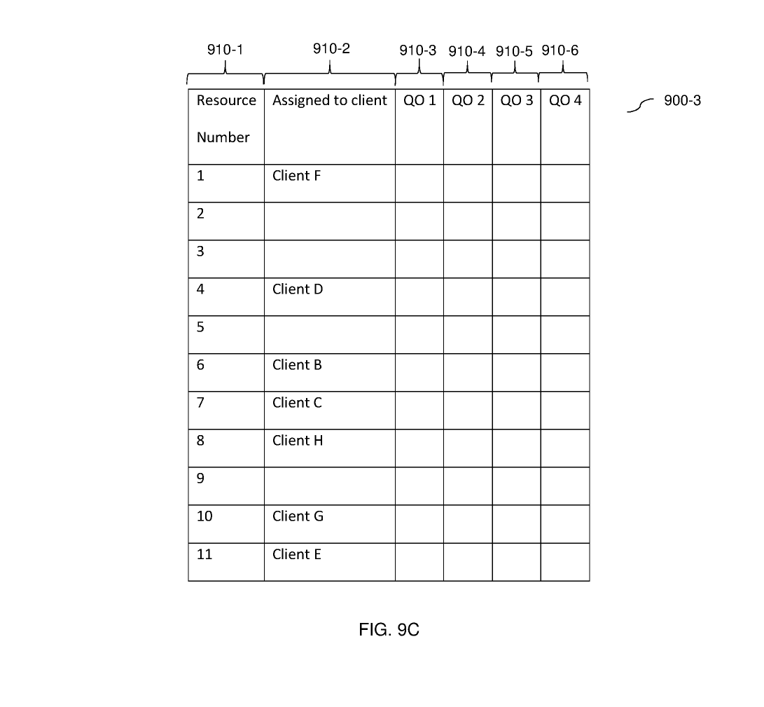

FIGS. 9A to 9C depict exemplary and non-limiting queue data tables 900-1 through 900-3, respectively, illustrating management of queues according to an embodiment. Each of data tables 900-1 through 900-3 includes columns 910-1 through 910-6. Column 910-1 illustrates resource numbers associated with each of a plurality of resources. Column 910-2 illustrates a current user that is assigned the resource associated with each respective resource number. Columns 910-3 through 910-6 illustrate the first, second, third, and fourth user in the queue order (QO), respectively.

As seen in FIG. 9A, resources associated with resource numbers 1 through 11 are associated with users including clients A through K, respectively. Client F is first in the queue order for each of resource numbers 1, 2, and 3, and client G is first in the queue order for resource numbers 9, 10, and 11. Client E is second in the queue order for each of resource numbers 1 and 11. Additionally, starred clients B, C, and H have indicated a resource preference for sitting in adjacent seats to each other.

As seen in FIG. 9B, upon cancellation of a reservation by client A, resource number 1 becomes available and is assigned to client F. The assignment of client F to resource number 6 as well as queue assignments of client F are removed, and the client E is advanced to first in the queue order for resource number 1.

As seen in FIG. 9C, upon cancellation of reservation by clients I, J, and K, resource numbers 9, 10, and 11 become available. Accordingly, resource number 10 is assigned to client G. Further, client E becomes first in the queue order for available resource number 11 and is assigned resource number 11. Clients B, C, and H are assigned to now available adjacent seats associated with resource numbers 6, 7, and 8, respectively.

It should be noted that the exemplary data tables 900-1 through 900-3 represent queue data as illustrated herein merely for simplicity purposes and without limitation on the disclosed embodiments. Queue information may be organized and/or illustrated differently without departing from the scope of the disclosure. Further, queue orders may include any number of users and are not limited to 4 users at a time.

FIG. 5 is an exemplary and non-limiting flowchart S350 illustrating a method for bidding for queue order according to an embodiment. In S510, a request to bid for a higher place in a queue order is received. The request may include, but is not limited to, an identification of a resource associated with the queue.

In S520, queue information related to the identified resource is retrieved. The queue information may include, but is not limited to, users in the queue, a queue order of the queue, a weight factor of each user in the queue, and so on. In S525, any of the retrieved queue information is caused to be displayed to the user.

In S530, a bid is received. The bid may include a weight factor value. The bid may be received respective of the displayed queue information. In an embodiment, if no bid is received, a default bid may be determined. For example, if a bidding user does not indicate how much he or she is willing to pay for a resource, the weight factor value may be determined to be 1 on a scale from 1 to 10.

In S540, it is determined whether the weight factor value has changed respective of the bid and, if so, execution continues with S550; otherwise, execution terminates. If no weight factor exists for the user, it may be determined that any new bid or weight factor is a change.

In S550, upon determining that the weight factor value has changed, the weight factor value is updated based on the change.

FIG. 6 is an exemplary and non-limiting flowchart S360 illustrating a method for queue-based resource recommendation according to an embodiment. In an embodiment, the method may begin upon determining that a resource selected by a user is unavailable. The method may result in recommending a resource to a user.

In S610, resource preferences of the user are identified. In an embodiment, the resource preferences may be identified based on current user inputs of the user or previous user inputs of the user (e.g., past resource preferences provided by the user).

In S620, availability information is retrieved based on the identified resource preferences. The retrieved availability information may include resource maps and/or queue information. The availability information may be retrieved from a plurality of web sources (e.g., the web sources 140). Each web source that availability information is retrieved from may be a web source including resources that match the resource preferences. As an example, if resource preferences of movie theater tickets in New York City for a particular movie are identified, the availability information may include seating charts from ticket sellers having tickets for the movie in New York City movie theaters. As another example, if resource preferences indicate a preference for a particular window seat, the availability information may be related to window seats in adjacent rows.

In an embodiment, S620 may further include retrieving information related to the resource preferences (e.g., whether a seat is an aisle seat, a location of a theater, a time of a showing or appointment, and so on).

In S630, a recommended resource is searched for based on the availability information and the resource preferences. In an embodiment, only resources that are available immediately (i.e., no queue required) are recommended.

In S640, it is determined whether a recommended resource has been identified and, if so, execution continues with S650; otherwise, execution terminates.

In S650, a notification indicating the recommended resource is generated and caused to be displayed to the user. In an embodiment, the recommendation notification may further include recommendations for associated resources.

In a further embodiment, the associated resource recommendations may be determined based on a resource plan of the user. The resource plan may include multiple resources used by the user and may be, but is not limited to, a travel itinerary, a movie double feature (or other multiple movie event), travel plans for going to or from a vacation or show, and so on. As a non-limiting example, if a resource plan includes changing trains during a trip and the user is recommended a ticket on a first train, the recommendation may also include a ticket on a second train that will depart from the station where the user will change within 15 minutes of the first train's arrival.

It should be noted that the embodiment described herein above with respect to FIG. 6 may be performed by the same system or service, or may be performed by a different entity.

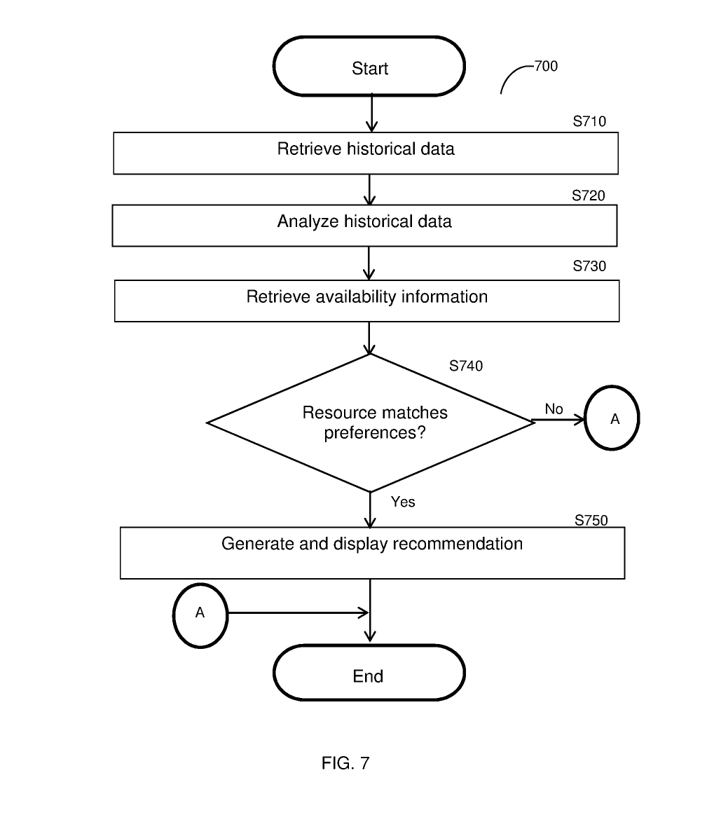

FIG. 7 is an exemplary and non-limiting flowchart 700 illustrating a method for generating resource recommendations based on a user history according to an embodiment. In an embodiment, the method may be performed by a server (e.g., the server 130).

In S710, historical data related to resource preferences of the user are retrieved. The retrieved historical data may be or may include a resource preference profile. Alternatively or collectively, the retrieved historical data may include previous resources selected by the user.

In S720, the retrieved historical data is analyzed to identify resource preferences of the user.

In S730, based on the analysis, availability information for resources matching the resource preferences may be retrieved from one or more data sources (e.g., web sources of resource owners). The availability information may include resource maps and/or queue information. A resource may match the resource preferences if, e.g., the resource meets one or more threshold preference requirements. The threshold preference requirements may be based on default requirements and/or requirements set by the user. The threshold preference requirements may include, e.g., a number of resource preferences that are met by the resource. As an example, a resource may match the resource preferences if the resource is associated with at least 3 of the resource preferences.

In S740, it is determined whether a resource matching the resource preferences is available and, if so, execution continues with S750; otherwise, execution terminates.

In S750, a recommendation including the matching resource is generated and caused to be displayed to the user. In an embodiment, the recommendation may include associated resources of a resource plan (e.g., a travel itinerary, a series of shows, and so on). In another embodiment, the recommendation may include promotional material for the recommended resource (e.g., a discount offer, an advertisement, and so on).

It should be noted that, in the embodiments disclosed herein, an entity seeking a resource is referred to as a “user” merely for simplicity purposes and without limitation on the disclosed embodiments. Other entities that may be represented as queued elements may be utilized without departing from the scope of the disclosure. Such entities may include, but are not limited to, passengers, guests, spectators, customers, patients, agents or representative thereof, and so on.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatic queue management of resources, comprising:
receiving a selection of an unavailable resource from a selecting user entity, wherein the selected resource is associated with a queue order including at least one queued entity;
updating the queue order of the selected resource based on the received selection;
monitoring resource availability information of the selected resource to identify changes in an availability of the selected resource; and
upon detecting a change in the availability of the selected resource:
automatically assigning the detected available resource to the next queued entity in the queue order; and
updating the queue order based on the assignment.

2. The method of claim 1, further comprising:
retrieving availability information related to a plurality of resources;
causing a display of the retrieved availability information, wherein the selection is received based on the displayed availability information.

3. The method of claim 1, wherein each queued entity is associated with a weight factor, wherein the queue order is based on the at least one weight factor.

4. The method of claim 3, further comprising:
receiving a new weight factor for a queued entity; and
updating, based on the received new weight factor, the queue order.

5. The method of claim 4, wherein receiving a new weight factor for a queued entity is based on bidding by the queued entity.

6. The method of claim 1, further comprising:
identifying resource preferences associated with the selecting queued entity;
determining, based on the monitoring, whether the selected resource is available; and
recommending, based on the resource preferences, an available resource, when the selected resource is unavailable.

7. The method of claim 1, wherein the unavailable resource is any of: a plane seat, a train seat, a theater seat, a sports venue seat, a bed, a table, a time slot, a room, a parking spot, and an item for purchase.

8. The method of claim 1, wherein monitoring resource availability information of the selected resource further comprises:
retrieving a current resource map associated with the selected resource; and
comparing the current resource map to a previous resource map associated with the selected resource, wherein a change in the availability of the selected resource is identified when the compared resource maps are different.

9. The method of claim 8, wherein the current resource map is iteratively retrieved and compared according to at least one frequency, wherein the at least one frequency is optimized based on machine learning of resource selection.

10. The method of claim 1, further comprising:
receiving at least one constraint from the resource owner; and
updating the queue order of the selected resource based on the received selection and the at least one constraint.

11. A computer readable medium having stored thereon instructions for causing one or more processing units to execute the method according to claim 1.

12. A system for queue management of resources, comprising:
a processing unit; and
a memory, the memory containing instructions that, when executed by the processing unit, configure the system to:
receiving a selection of an unavailable resource from a selecting user entity, wherein the selected unavailable resource is associated with a queue order including at least one queued entity;
updating the queue order of the selected resource based on the received selection;
continuously monitoring resource availability information of the selected resource to detect changes in availability of the selected resource; and
upon detecting an availability of the selected resource:
automatically assigning the detected available resource to the next queued entity in the queue order; and
updating the queue order based on the assignment.

13. The system of claim 12, wherein the system is further configured to:
retrieve availability information related to a plurality of resources;
cause a display of the retrieved availability information, wherein the selection is received based on the displayed availability information.

14. The system of claim 12, wherein each queued entity is associated with a weight factor, wherein the queue order is based on the at least one weight factor.

15. The system of claim 14, wherein the system is further configured to:
receive a new weight factor for a queued entity; and
update, based on the received new weight factor, the queue order.

16. The system of claim 15, wherein receiving a new weight factor for a queued entity is based on bidding by the queued entity.

17. The system of claim 12, wherein the system is further configured to:
identify resource preferences associated with the selecting queued entity;
determine, based on the monitoring, whether the selected resource is available; and
recommend, based on the resource preferences, an available resource, when the selected resource is unavailable.

18. The system of claim 12, wherein the unavailable resource is any of: a plane seat, a train seat, a theater seat, a sports venue seat, a bed, a table, a time slot, a room, a parking lot, and an item for purchase.

19. The system of claim 12, wherein the system is further configured to:
retrieve a current resource map associated with the selected resource; and
compare the current resource map to a previous resource map associated with the selected resource, wherein the changes in the availability of the selected resource are identified when the compared resource maps are different.

20. The system of claim 19, wherein the current resource map is iteratively retrieved and compared according to at least one frequency, wherein the at least one frequency is optimized based on machine learning of resource selection.

21. The system of claim 12, wherein the system is further configured to:
receive at least one constraint from the resource owner; and
update the queue order of the selected resource based on the received selection and the at least one constraint.

22. A method for generating resource recommendations based on a resource preference history, comprising:
retrieving historical data related to resource preferences;
analyzing the historical data to identify the resource preferences;
retrieving availability information of at least one resource matching the resource preferences;
determining, based on the availability information, whether each matching resource is available;
upon determining that at least one matching resource is available, generating a recommendation including one of the at least one available matching resource.
